(19) United States
(12) Patent Application Publication
(10) Pub. No.: US 2021/0103990 A1
(43) Pub. Date: Apr. 8, 2021

(54) AUTOMATED REAL TIME MORTGAGE SERVICING AND WHOLE LOAN VALUATION

(71) Applicant: BLUE WATER FINANCIAL TECHNOLOGIES, LLC, St. Louis Park, MN (US)

(72) Inventors: Alan Pervez Qureshi, Excelsior, MN (US); He Lu, Maplewood, MN (US); Josh Freivogel, San Francisco, CA (US); Travis LaMar, Shoreview, MN (US)

(21) Appl. No.: 17/063,856

(22) Filed: Oct. 6, 2020

Related U.S. Application Data
(60) Provisional application No. 62/911,735, filed on Oct. 7, 2019.

(51) Int. Cl. G06Q 40/06; G06Q 40/02; G06Q 10/10; G06N 20/00; G06F 9/54

(52) U.S. Cl. CPC G06Q 40/06; G06Q 40/025; G06F 9/541; G06N 20/00; G06Q 10/10

(57) ABSTRACT

A system is disclosed. The system has a mortgage servicing and loan valuation module, comprising computer-executable code stored in non-volatile memory, a processor, and a network component configured to communicate with the mortgage servicing and loan valuation module and the processor. The mortgage servicing and loan valuation module, the processor, and the network component are configured to receive a pricing file via the network component, provide a plurality of machine learning regression models, determine one or more of the plurality of machine learning regression models to apply to the pricing file, apply the determined one or more of the plurality of machine learning regression models to the pricing file, and transfer a priced portfolio to the network component.

### CROSS-REFERENCE TO RELATED APPLICATIONS

This application claims priority to U.S. provisional patent application 62/911,735 filed on Oct. 7, 2019, and entitled “AUTOMATED REAL TIME MORTGAGE SERVICING AND WHOLE LOAN VALUATION,” the entire disclosure of which is incorporated herein by reference.

### TECHNICAL FIELD

The present disclosure is directed to a system and method for mortgage servicing, and more particularly, to a system and method for automated real time mortgage servicing and whole loan valuation.

### BACKGROUND OF THE DISCLOSURE

Conventional industry practice for pricing of assets traded in the secondary market for mortgages typically involve market participants specifying static parameters to make pricing adjustments based on a relatively limited number of loan features, which are calculated against benchmark prices set relatively infrequently (e.g., usually at the beginning of the day). Using these conventional methods, buyers and sellers then typically transact loans at materially different prices than what their accounting methods assume based on the prevailing market prices at the time of the transaction and additional loan feature information.

Approaches to solving for this discrepancy have not been proffered due to the high dimensionality of the problem and the small window of time for which a solution would be relevant. Accordingly, participants in the secondary market for mortgage loans, mortgage servicing rights, and mortgage-backed securities suffer from inaccurate pricing calculations due to static parameters being used to model variables.

The exemplary disclosed system and method of the present disclosure is directed to overcoming one or more of the shortcomings set forth above and/or other deficiencies in existing technology.

### SUMMARY OF THE DISCLOSURE

In one exemplary aspect, the present disclosure is directed to a system. The system includes a mortgage servicing and loan valuation module, comprising computer-executable code stored in non-volatile memory, a processor, and a network component configured to communicate with the mortgage servicing and loan valuation module and the processor. The mortgage servicing and loan valuation module, the processor, and the network component are configured to receive a pricing file via the network component, provide a plurality of machine learning regression models, determine one or more of the plurality of machine learning regression models to apply to the pricing file, apply the determined one or more of the plurality of machine learning regression models to the pricing file, and transfer a priced portfolio to the network component.

In another aspect, the present disclosure is directed to a method. The method includes receiving a pricing file via a network component, providing a plurality of k-nearest neighbors models, determining one or more of the plurality of k-nearest neighbors models to apply to the pricing file using a mortgage servicing and loan valuation module and a processor, applying the determined one or more of the plurality of k-nearest neighbors models to the pricing file, and transferring a priced portfolio to the network component.

### BRIEF DESCRIPTION OF THE DRAWINGS

Accompanying this written specification is a collection of drawings of exemplary embodiments of the present disclosure. One of ordinary skill in the art would appreciate that these are merely exemplary embodiments, and additional and alternative embodiments may exist and still within the spirit of the disclosure as described herein.

FIG. 1 is a chart illustration of at least some exemplary embodiments of the present disclosure;

FIG. 2 is a chart illustration of at least some exemplary embodiments of the present disclosure;

FIG. 3 is a chart illustration of at least some exemplary embodiments of the present disclosure;

FIG. 4 is a chart illustration of at least some exemplary embodiments of the present disclosure;

FIG. 5 is a chart illustration of at least some exemplary embodiments of the present disclosure;

FIG. 6 is a chart illustration of at least some exemplary embodiments of the present disclosure;

FIG. 7 is a chart illustration of at least some exemplary embodiments of the present disclosure;

FIG. 8 is a chart illustration of at least some exemplary embodiments of the present disclosure;

FIG. 9 is a chart illustration of at least some exemplary embodiments of the present disclosure;

FIG. 10 is a chart illustration of at least some exemplary embodiments of the present disclosure;

FIG. 11 is a chart illustration of at least some exemplary embodiments of the present disclosure;

FIG. 12 is a chart illustration of at least some exemplary embodiments of the present disclosure;

FIG. 13 is a chart illustration of at least some exemplary embodiments of the present disclosure;

FIG. 14 is a schematic illustration of at least some exemplary embodiments of the present disclosure;

FIG. 15 is a chart illustration of at least some exemplary embodiments of the present disclosure;

FIG. 16 is a schematic illustration of at least some exemplary embodiments of the present disclosure;

FIG. 17 is a chart illustration of at least some exemplary embodiments of the present disclosure;

FIG. 18 illustrates an exemplary process of at least some exemplary embodiments of the present disclosure;

FIG. 19 is a schematic illustration of an exemplary computing device, in accordance with at least some exemplary embodiments of the present disclosure;

FIG. 20 is a schematic illustration of an exemplary network, in accordance with at least some exemplary embodiments of the present disclosure; and

FIG. 21 is a schematic illustration of an exemplary network, in accordance with at least some exemplary embodiments of the present disclosure.

### DETAILED DESCRIPTION AND INDUSTRIAL APPLICABILITY

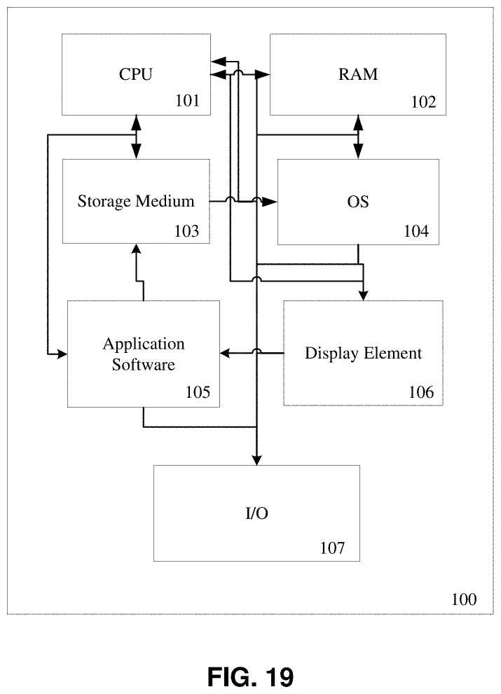

The exemplary disclosed system and method may be an automated real time mortgage servicing valuation system and method. The exemplary disclosed system may include a mortgage servicing and loan pricing engine as described for example herein. The mortgage servicing and loan pricing engine may include computing device components, modules, processors, network components, and other suitable components that may be similar to the exemplary disclosed components described below regarding FIGS. 19-21. For example, the exemplary disclosed system may include a mortgage servicing and loan valuation module, including computer-executable code stored in non-volatile memory, and a processor.

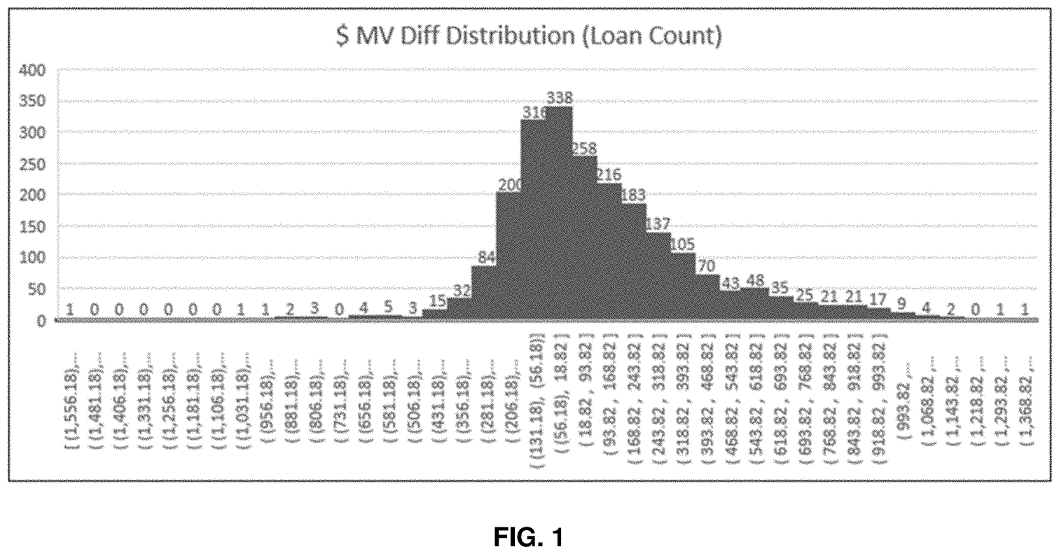

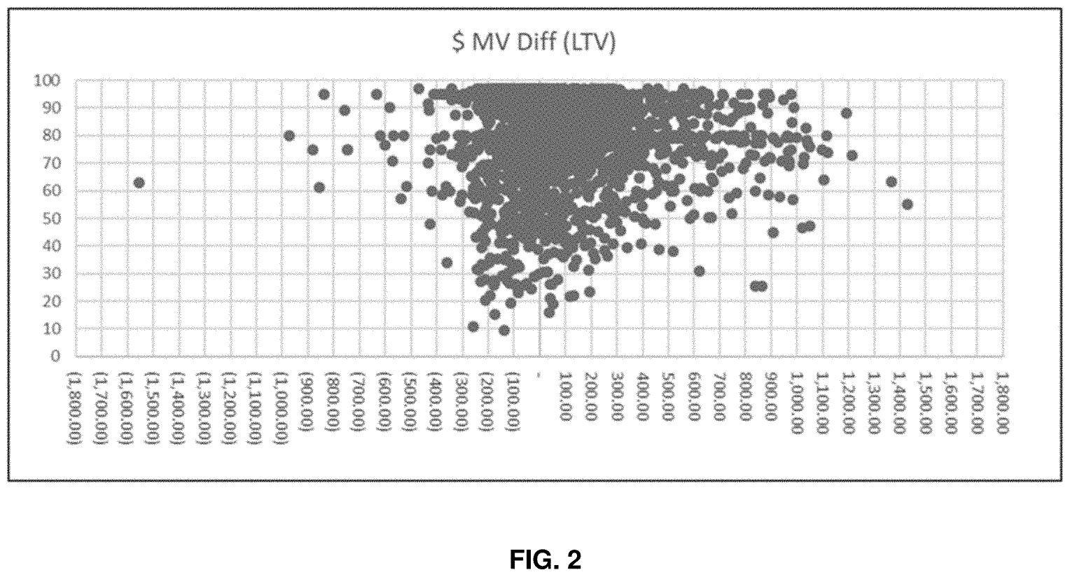

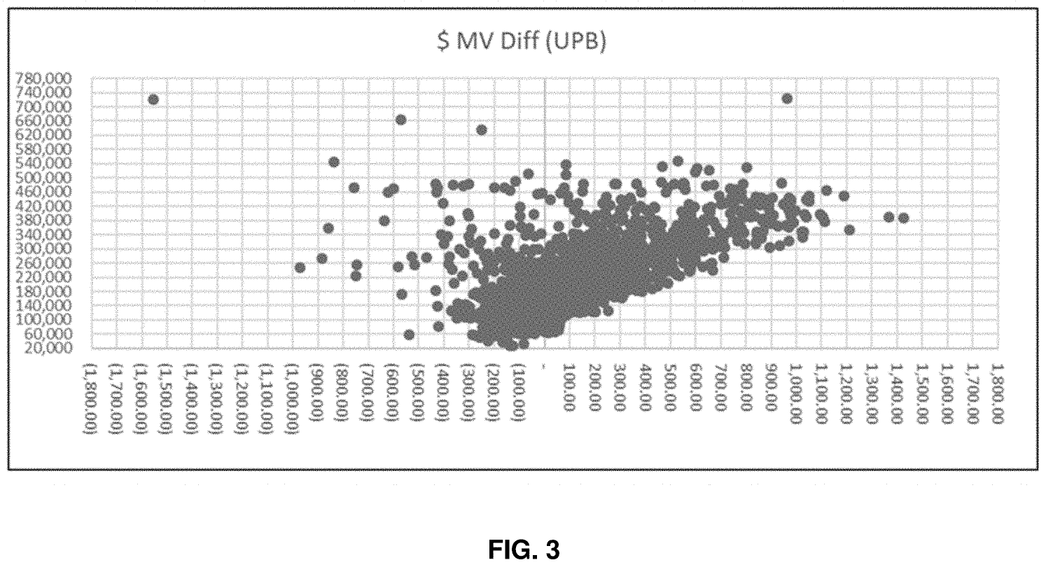

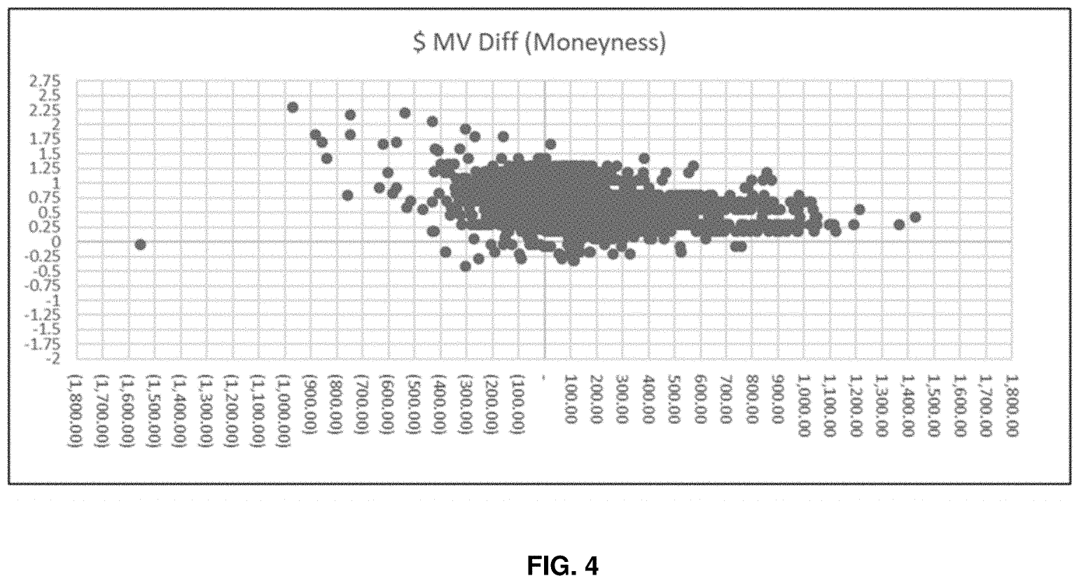

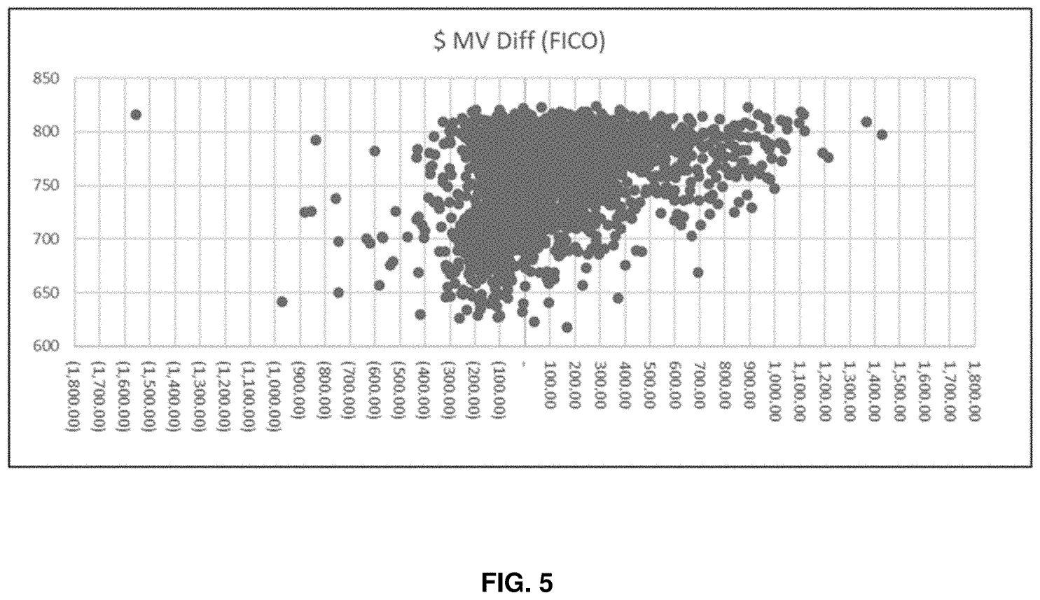

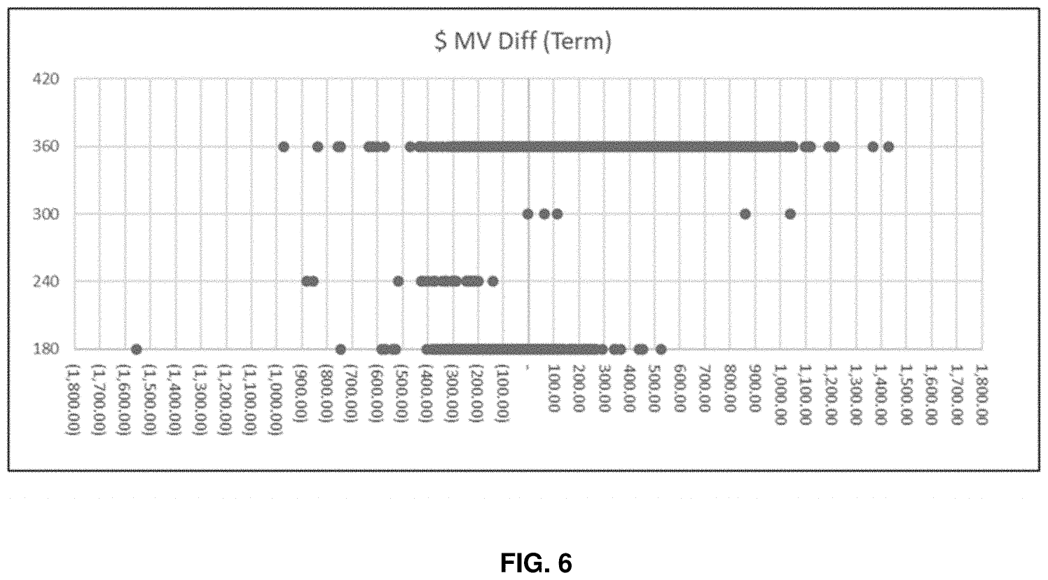

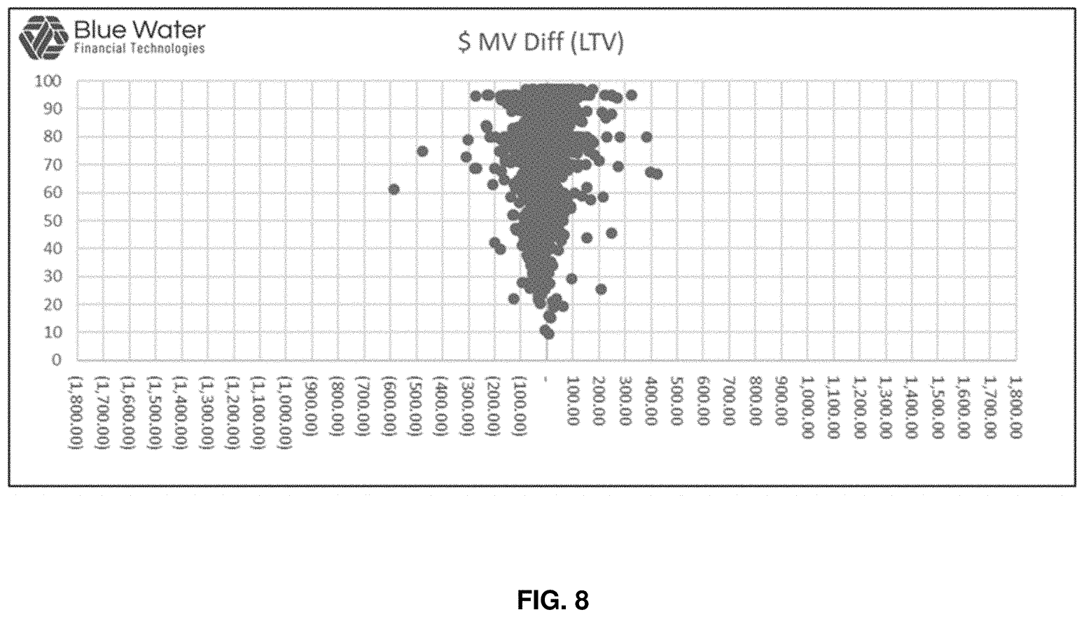

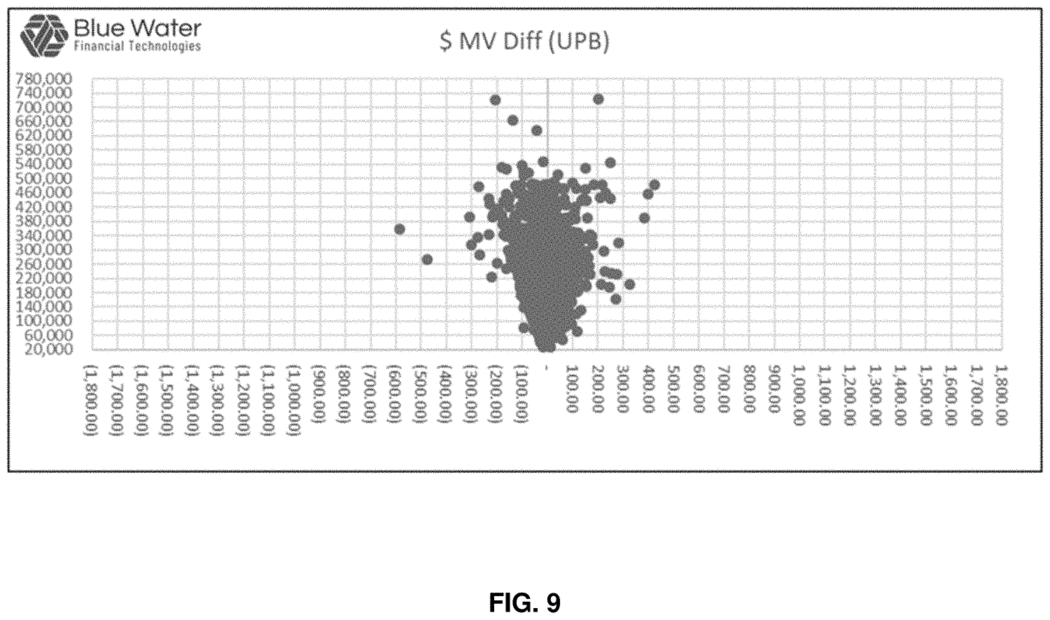

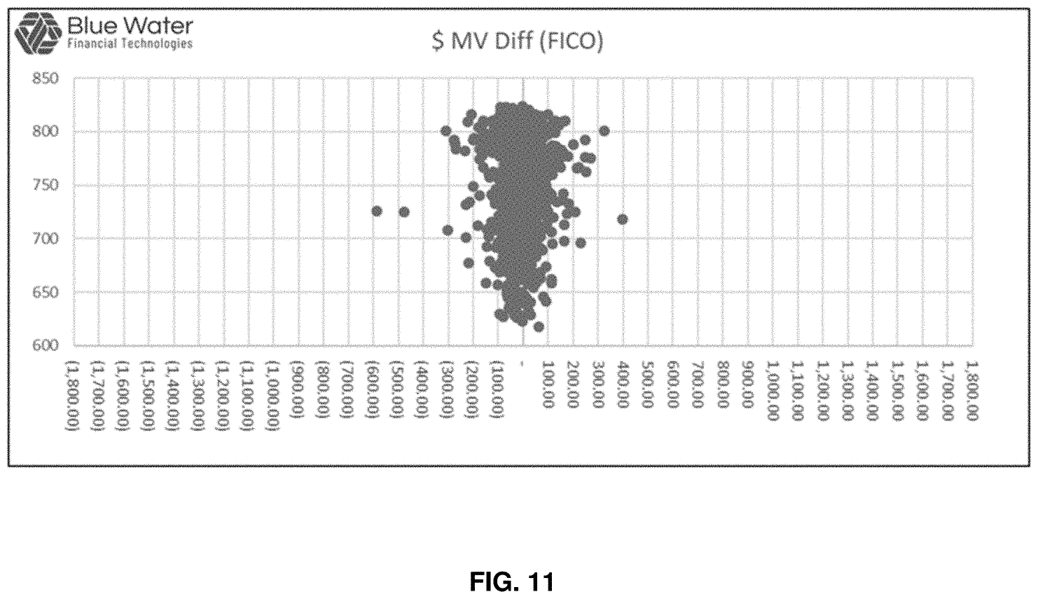

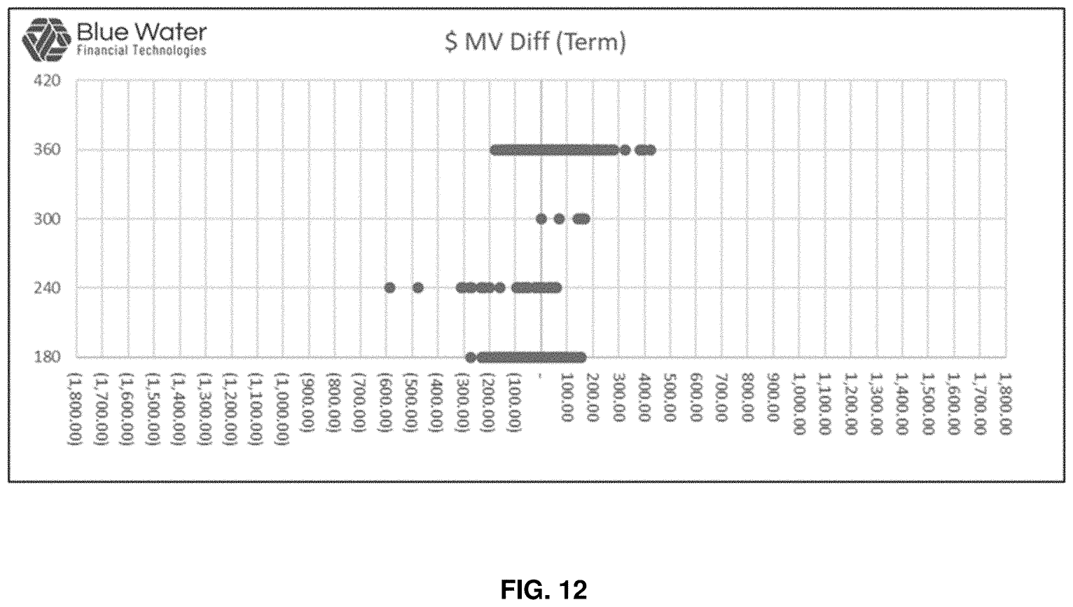

The exemplary disclosed system and method may reduce (e.g., provably reduce) a mean error of pricing models introduced by market fluctuations within one or more time sensitive constraints present or existing during secondary mortgage market transactions (e.g., in the conduct of these transactions). For example, the mean error of pricing models introduced by market fluctuations may be reduced by exemplary disclosed statistical modeling and algorithms (e.g., software) as described herein and as illustrated in FIGS. 1-13.

The exemplary disclosed system and method may provide an efficient (e.g., streamlined) method that provides a low threshold for error, for example as desired by market participants such as participants in secondary markets for mortgages. For example, the exemplary disclosed system and method may provide participants with a digital method (e.g., fully digital method) for performing transactions. The exemplary disclosed system and method may also reduce a dimensionality of possible permutations (e.g., for solving a problem) down to a number that is computationally feasible to solve (e.g., to exhaustively solve for). The exemplary disclosed system and method may provide solutions in a practical (e.g., relatively short) period of time. The exemplary disclosed system and method may also return prices to buyers and sellers instantaneously (e.g., instantaneously or nearly instantaneously) regardless of market movements.

In at least some exemplary embodiments, the exemplary disclosed system and method may provide a low threshold for error by eliminating local maxima (e.g., all local maxima) beyond a preliminary threshold.

In at least some exemplary embodiments, the exemplary disclosed system and method may provide a low threshold for error by interpolating on a continuous plane using a regression based on k-nearest neighbors (e.g., KNN). For example, a target may be predicted based on the regression. The regression based on k-nearest neighbors may include prediction of a target by local interpretation of targets associated with nearest neighbors in a data set.

In at least some exemplary embodiments, the exemplary disclosed system and method may be platform agnostic. For example, the exemplary disclosed system may plug into any suitable third party system (e.g., third party software solutions).

In at least some exemplary embodiments, the exemplary disclosed system and method may operate in real time (e.g., real time or near real time) relative to market data sources. For example, the exemplary disclosed system and method may refresh reference market rates (e.g., certain user defined inputs such as but not necessarily limited to interest rate swap prices, secondary mortgage reference market rates, and money market instrument prices) in real time or near real time (e.g., continuously or at or any desired intervals).

The exemplary disclosed system and method may provide improved accuracy. For example, the exemplary disclosed system and method may provide a continuous pricing function that reduces error created by assigning value using discrete pricing scenarios.

The exemplary disclosed system and method may provide improved operational efficiency. For example, the exemplary disclosed system and method may provide for grids associated with secondary markets for mortgages that may be updated as desired.

In at least some exemplary embodiments, the exemplary disclosed system and method may provide a generalized method for use in any desired time sensitive applications. The exemplary disclosed system may include any suitable user interface that may be developed to any desired parameters (e.g., specified parameters). The exemplary disclosed system may also utilize machine learning techniques, as described for example below, to initialize and tune hyperparameters.

FIGS. 1-6 illustrate an exemplary comparison of Market Value ($) Variance (e.g., expressed in USD or $). For example as illustrated in FIGS. 1-6, a comparison of co-issue grids vs. loan level cash flow valuation is shown.

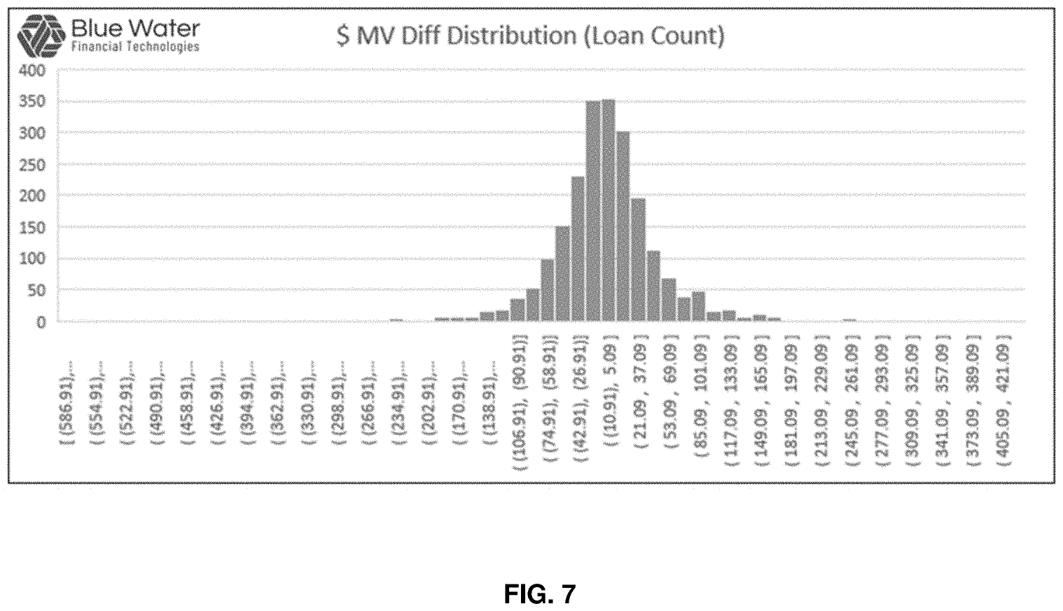

FIGS. 7-12 illustrate an exemplary comparison of Market Value ($) Variance (e.g., expressed in USD or $). For example as illustrated in FIGS. 7-12, a comparison of an embodiment of the exemplary disclosed system (e.g., Blue Water API) vs. loan level cash flow valuation is shown.

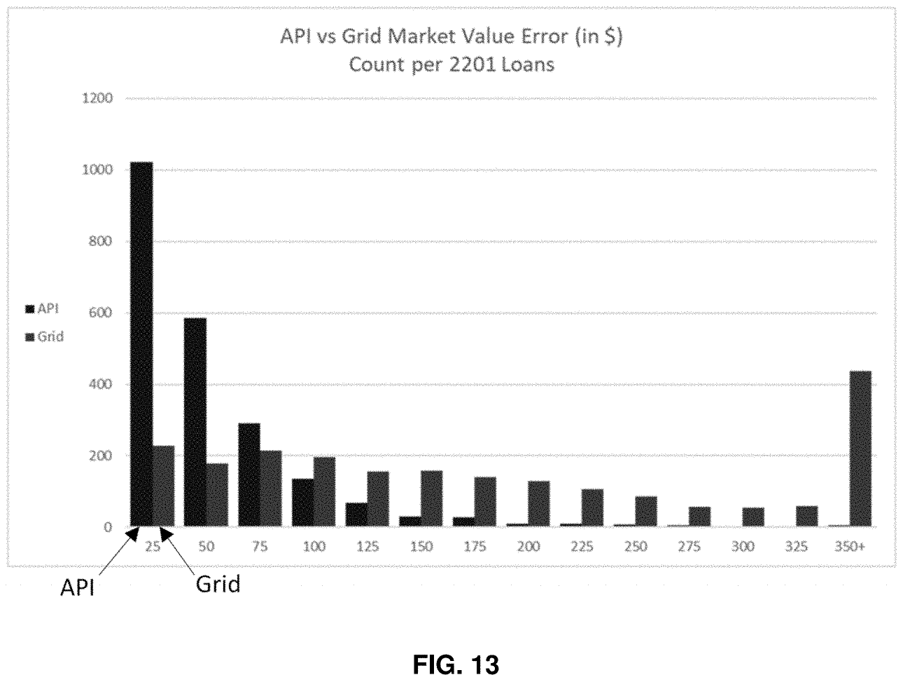

FIG. 13 illustrates an exemplary comparison of Market Value ($) Variance (e.g., expressed in USD or $). For example as illustrated in FIG. 13, a comparison of an embodiment of the exemplary disclosed system (e.g., an Application Programming Interface such as any suitable cloud-based or Internet-based API such as for example Blue Water API) vs. an exemplary disclosed grid is shown. FIG. 13 illustrates an exemplary comparison using the same set of loans (e.g., 2201 loans) and market rates.

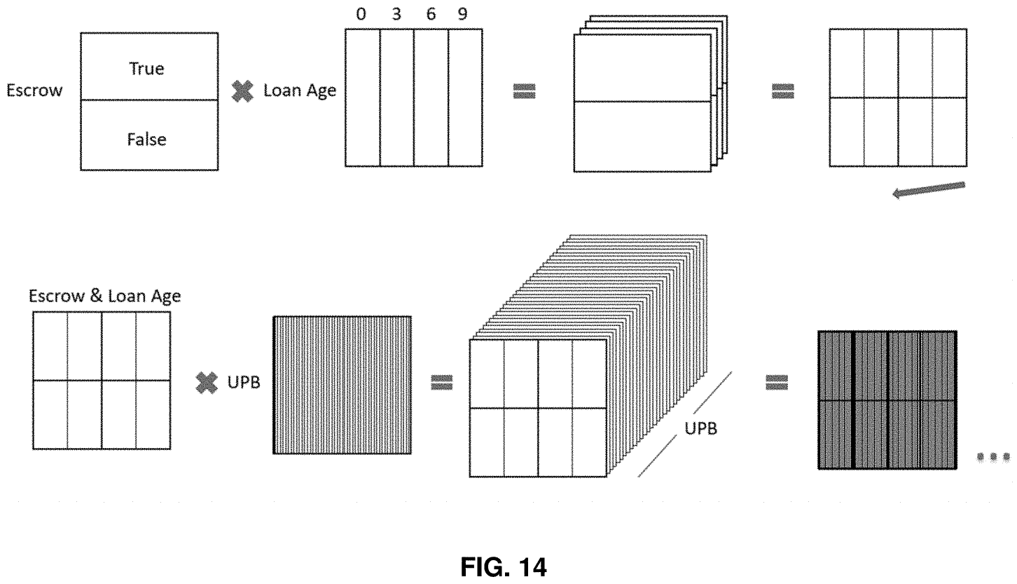

FIGS. 14-17 illustrate an exemplary operation of the exemplary disclosed system and method. As illustrated in FIG. 14, the exemplary disclosed system may create a pricing file (e.g., a Bulk Loan Level Pricing File such as a bulk mortgage loan level pricing file) and provide the pricing file to a user such as a client. The user may price the pricing file and provide the pricing file as input data to the system. The exemplary disclosed system may determine a Par Note Rate construction (e.g., based on the operation of the system and input from the user). The exemplary disclosed system may standardize the pricing file input by the user (e.g., the returned pricing file) and may upload the standardized pricing file to a backend database of the exemplary disclosed system. The exemplary disclosed system may price (e.g., based on the operation of the system and input from the user) a sample portfolio (e.g. about 2000 recent loans) using any suitable data and/or criteria such as a model input as data by the user (e.g., a client's model) and/or software or algorithms of the exemplary disclosed system. The exemplary disclosed system may reconcile pricing and agree to aggregate price tolerances (e.g., based on an operation of the system and input from the user). The exemplary disclosed system may determine a frequency of refresh of the pricing file (e.g., based on an operation of the system and input from the user). A multiple k-nearest neighbors (e.g., KNN) model may be applied to the pricing file by the exemplary disclosed system and method for example as described below.

As illustrated in FIG. 14, the exemplary disclosed pricing file may be constructed from any desired permutations (e.g., all permutations) across multiple inputs: for example, note rate, escrow, loan age, UPB (unpaid principal balance), LTV (loan-to-value ratio), FICO (e.g., including FICO® score data), DTI (debt-to-income ratio), and any other suitable inputs.

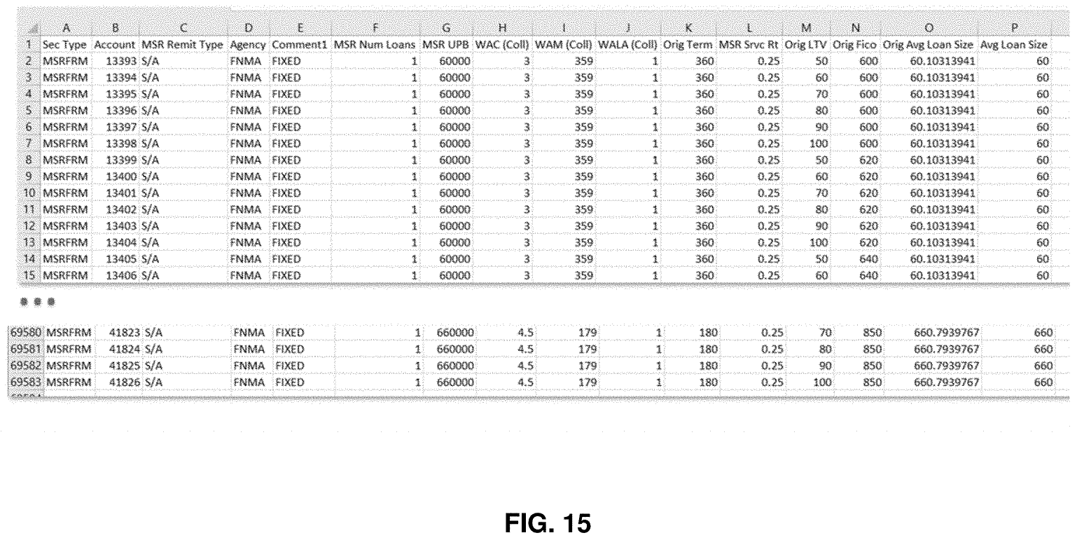

As illustrated in FIG. 15, when a user (e.g., a buyer or a client) runs the exemplary disclosed pricing file through a user's process (e.g., the user's loan-level valuation method) and provides data of the results to the exemplary disclosed system, the exemplary disclosed system may perform the exemplary disclosed method with a granular representation (e.g., much more granular representation, relatively) of some or all possible loan permutations. The exemplary disclosed system may then interpolate between the granular population and achieve near continuous pricing in some or all possible market states and loan characteristics.

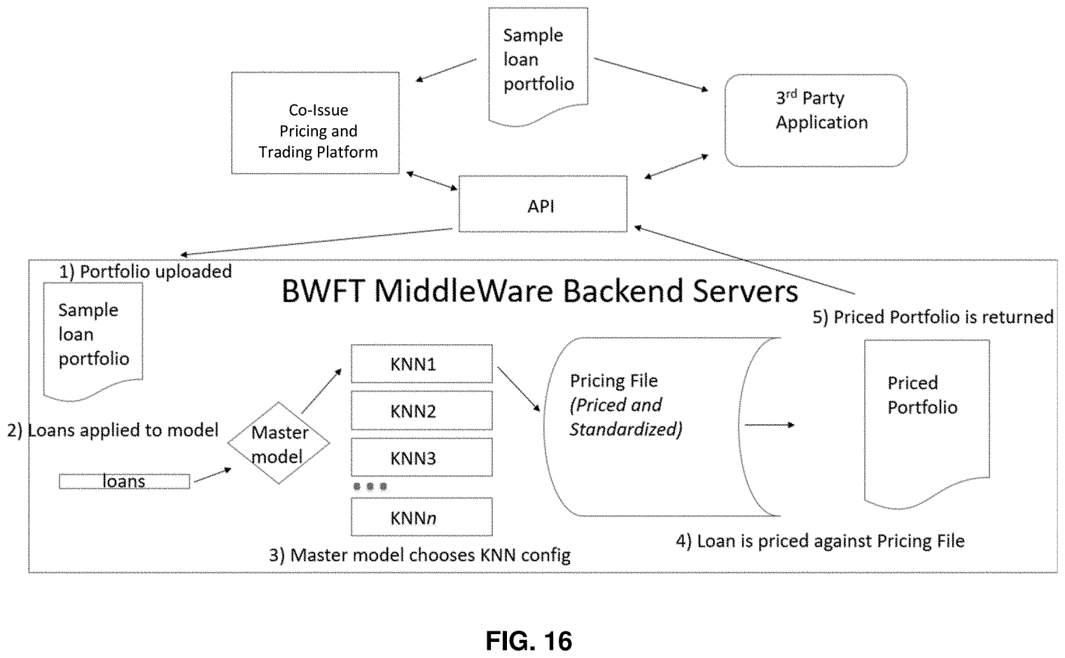

FIG. 16 illustrates a diagram of an exemplary embodiment of a master model. The exemplary disclosed master model may utilize any suitable regression method or model such as a non-parametric method or model. The exemplary disclosed master model may utilize a machine learning algorithm or model for solving regression problems. For example, the exemplary disclosed master model may utilize a plurality of machine learning regression models. In at least some exemplary embodiments, the exemplary disclosed system and method may include a multiple k-nearest neighbors (e.g., KNN) model, e.g., designed based on domain knowledge: F(KNN1, KNN2 . . . KNNn). The exemplary disclosed system and method (e.g., the master model) may determine (e.g., select) which KNN to use (e.g., may also be designed based on domain knowledge). For example, a priced pricing file may be uploaded via API, a multiple KNN model may be applied (e.g., the master model may determine or select a best performing KNN model), and the API may return prices. If more than one KNN model has been selected by the master function, the result may be based on the weighted average of all the selected model result. The exemplary disclosed system and method may utilize artificial intelligence operations (e.g., lazy learning and/or instance-based learning) for example as described herein in determining one or more KNN models to apply to the pricing file.

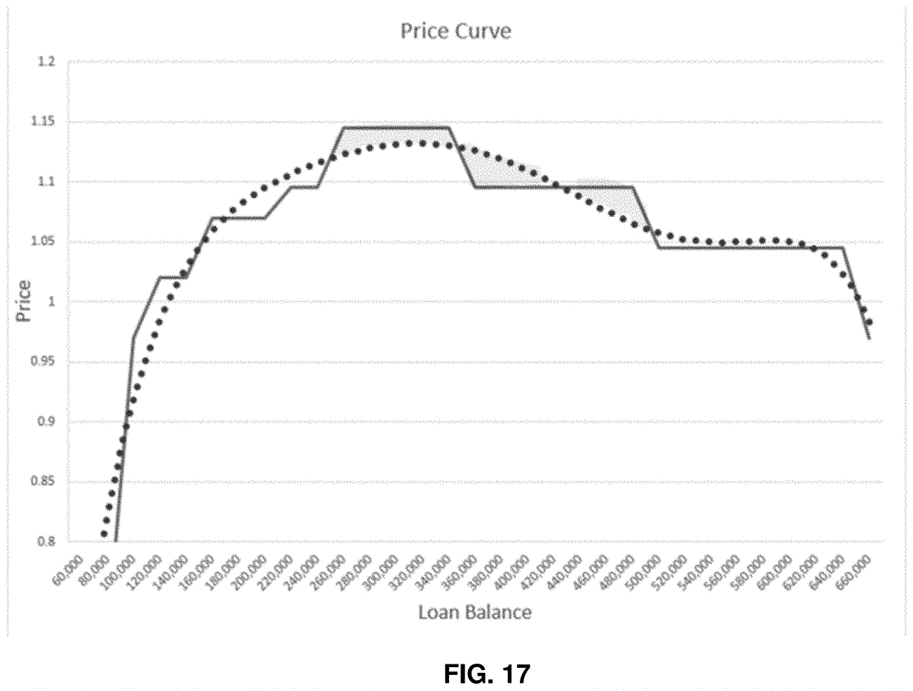

As illustrated in FIG. 17, the exemplary disclosed system and method (e.g., including a Middleware solution) may effectively price loans on a continuous plane, while static grids may be in (e.g., stuck in) discrete buckets. The shaded area shown in FIG. 17 depicts inaccuracies of grids that may exist as compared to the exemplary disclosed method (e.g., using Middleware).

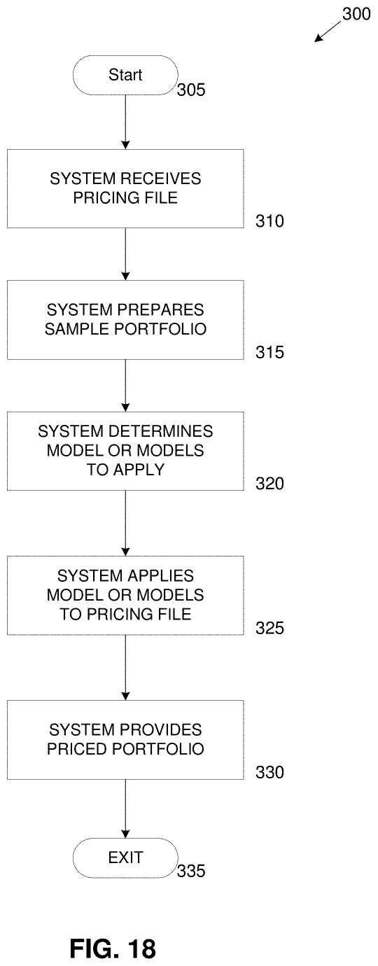

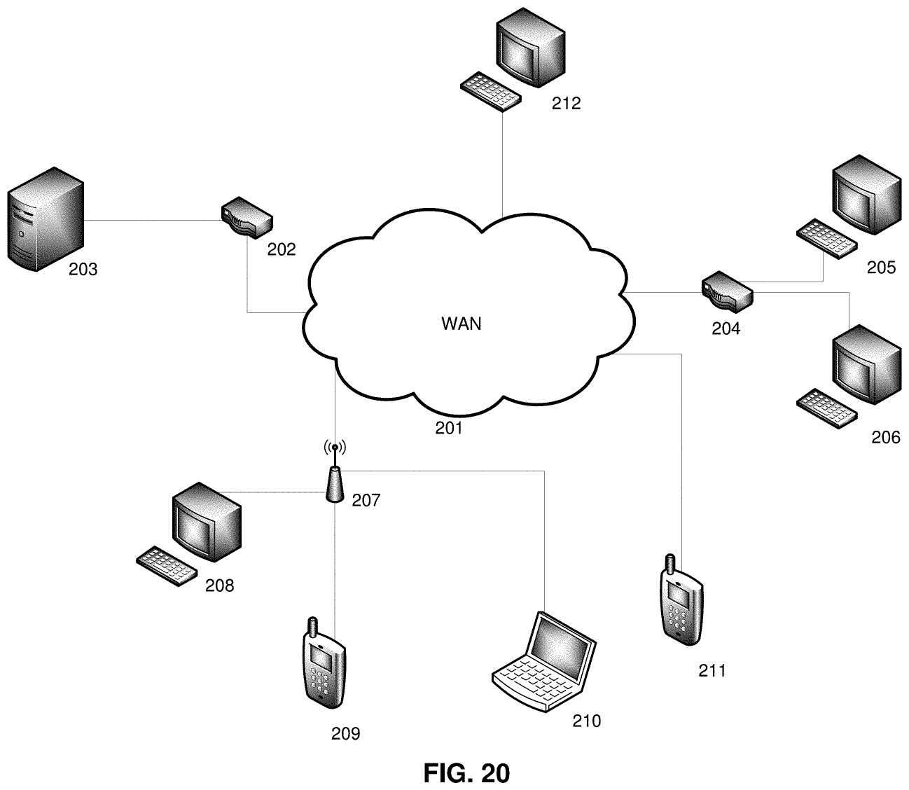

FIG. 18 illustrates an exemplary operation of the exemplary disclosed system. Process 300 begins at step 305. At step 310, the exemplary disclosed system may receive a pricing file (for example from a user). The pricing file may be received by any suitable technique such as cloud-based methods (e.g., uploaded via API) or any other suitable technique for example as described herein. For example, the pricing file may be received via a network component of the exemplary disclosed system that may for example be similar to the network components described herein regarding FIG. 20. At step 315, the exemplary disclosed system may upload and/or prepare a sample portfolio (e.g., a sample loan portfolio including loans).

At step 320, the exemplary disclosed system may determine a model or models to apply to the pricing file. For example as described above, the exemplary disclosed system may operate to select one or more regression (e.g., KNN) models to apply to the pricing file.

The exemplary disclosed system may apply the selected regression (e.g., KNN) model or models to the pricing file at step 325. For example as described above, the exemplary disclosed system may maintain a low threshold for error by eliminating local maxima (e.g., all local maxima) beyond a preliminary threshold. Also for example as described above, the exemplary disclosed system may provide a low threshold for error by interpolating on a continuous plane using a regression based on k-nearest neighbors. In at least some exemplary embodiments, loans (e.g., loans of the sample portfolio) may be priced against the pricing file at step 325.

At step 330, the exemplary disclosed system may provide the priced portfolio to the user. The priced portfolio may be provided for example by the exemplary disclosed techniques described herein (e.g., cloud-based methods such as via an API) via the exemplary disclosed network component. Process 300 ends at step 335.

In at least some exemplary embodiments, the exemplary disclosed system and method may be a system and method for mortgage servicing valuation. The system and method may include a mortgage servicing and loan pricing engine. The system and method may reduce a mean error of pricing models introduced by market fluctuations within one or more time sensitive constraints present or existing during secondary mortgage market transactions.

In at least some exemplary embodiments, the exemplary disclosed system may include a mortgage servicing and loan valuation module, comprising computer-executable code stored in non-volatile memory, a processor, and a network component configured to communicate with the mortgage servicing and loan valuation module and the processor. The mortgage servicing and loan valuation module, the processor, and the network component may be configured to receive a pricing file via the network component, provide a plurality of machine learning regression models, determine one or more of the plurality of machine learning regression models to apply to the pricing file, apply the determined one or more of the plurality of machine learning regression models to the pricing file, and transfer a priced portfolio to the network component. The mortgage servicing and loan valuation module, the processor, and the network component may be further configured to receive a plurality of update data for the pricing file in real time. The plurality of update data for the pricing file may include real time changes to reference market rates. The plurality of machine learning regression models may be a plurality of k-nearest neighbors models. Applying the determined one or more of the plurality of machine learning regression models to the pricing file may include eliminating all local maxima beyond a preliminary threshold. Applying the determined one or more of the plurality of machine learning regression models to the pricing file may include interpolating on a continuous plane using a regression based on k-nearest neighbors. The pricing file may be a bulk mortgage loan level pricing file. The pricing file may include at least one data selected from the group of note rate data, escrow data, loan age data, UPB data, LTV data, FICO data, DTI data, and combinations thereof. The network component may include an internet-based API. Applying the determined one or more of the plurality of machine learning regression models to the pricing file may include interpolating between a granular population to provide continuous pricing in all market states and loan characteristics.

In at least some exemplary embodiments, the exemplary disclosed method may include receiving a pricing file via a network component, providing a plurality of k-nearest neighbors models, determining one or more of the plurality of k-nearest neighbors models to apply to the pricing file using a mortgage servicing and loan valuation module and a processor, applying the determined one or more of the plurality of k-nearest neighbors models to the pricing file, and transferring a priced portfolio to the network component. Determining one or more of the plurality of k-nearest neighbors models to apply to the pricing file using a mortgage servicing and loan valuation module and a processor may include utilizing machine learning operations. The exemplary disclosed method may also include receiving a plurality of update data for the pricing file. The exemplary disclosed method may further include updating the pricing file in real time as each of the plurality of update data is received. The plurality of update data may include real time changes to reference market rates.

In at least some exemplary embodiments, the exemplary disclosed system may include a mortgage servicing and loan valuation module, comprising computer-executable code stored in non-volatile memory, a processor, and a network component including an API and configured to communicate with the mortgage servicing and loan valuation module and the processor. The mortgage servicing and loan valuation module, the processor, and the network component may be configured to receive a pricing file via the network component, provide a plurality of k-nearest neighbors models, determine one or more of the plurality of k-nearest neighbors models to apply to the pricing file, apply the determined one or more of the plurality of k-nearest neighbors models to the pricing file, transfer a priced portfolio to the network component, and receive a plurality of update data for the pricing file in real time. The mortgage servicing and loan valuation module, the processor, and the network component may be further configured to update the pricing file in real time as each of the plurality of update data is received. The plurality of update data for the pricing file may include real time changes to reference market rates. Applying the determined one or more of the plurality of k-nearest neighbors models to the pricing file may include eliminating all local maxima beyond a preliminary threshold. Applying the determined one or more of the plurality of k-nearest neighbors models to the pricing file may include interpolating on a continuous plane using a regression based on k-nearest neighbors.

The exemplary disclosed system and method may be used in any suitable application for reducing an error of mathematical models such as pricing models. For example, the exemplary disclosed system and method may be used in any suitable application for reducing a mean error of pricing models introduced by market fluctuations within one or more time sensitive constraints present or existing during secondary mortgage market transactions. Also for example, the exemplary disclosed system and method may be used in any suitable application for providing efficient analytics and transactions services to loan and mortgage-servicing buyers and sellers.

The exemplary disclosed system and method may provide an efficient and effective technique for reducing a mean error of pricing models for the secondary mortgage market. The exemplary disclosed system and method may thereby improve accuracy of modeling for the secondary mortgage market.

An illustrative representation of a computing device appropriate for use with embodiments of the system of the present disclosure is shown in FIG. 19. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wifi, Bluetooth, USB). Useful examples include, but are not limited to, personal computers, smart phones, laptops, mobile computing devices, tablet PCs, and servers. Multiple computing devices can be operably linked to form a computer network in a manner as to distribute and share one or more resources, such as clustered computing devices and server banks/farms.

Various examples of such general-purpose multi-unit computer networks suitable for embodiments of the disclosure, their typical configuration and many standardized communication links are well known to one skilled in the art, as explained in more detail and illustrated by FIG. 20, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 20, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 20, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G, 5G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

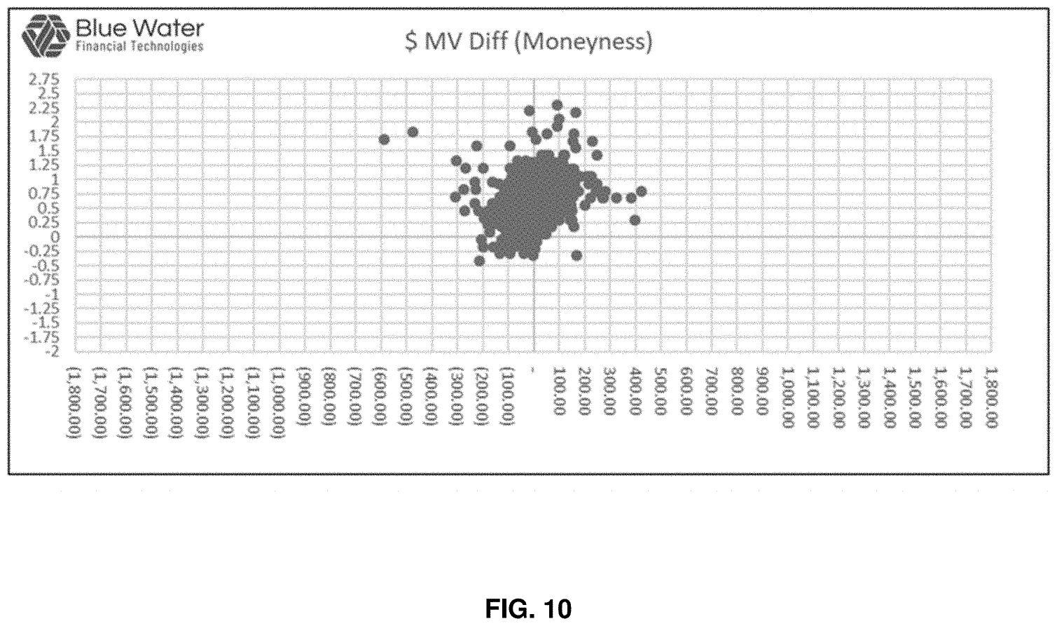

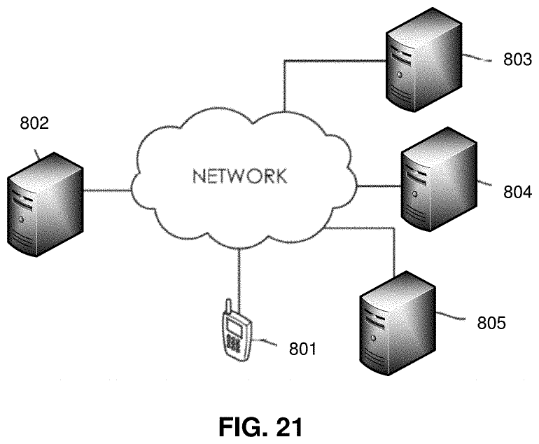

Turning now to FIG. 21, a continued schematic overview of a cloud-based system in accordance with an embodiment of the present invention is shown. In FIG. 10, the cloud-based system is shown as it may interact with users and other third party networks or APIs (e.g., APIs associated with the exemplary disclosed E-Ink displays). For instance, a user of a mobile device 801 may be able to connect to application server 802. Application server 802 may be able to enhance or otherwise provide additional services to the user by requesting and receiving information from one or more of an external content provider API/website or other third party system 803, a constituent data service 804, one or more additional data services 805 or any combination thereof. Additionally, application server 802 may be able to enhance or otherwise provide additional services to an external content provider API/website or other third party system 803, a constituent data service 804, one or more additional data services 805 by providing information to those entities that is stored on a database that is connected to the application server 802. One of ordinary skill in the art would appreciate how accessing one or more third-party systems could augment the ability of the system described herein, and embodiments of the present invention are contemplated for use with any third-party system.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

In at least some exemplary embodiments, the exemplary disclosed system may utilize sophisticated machine learning and/or artificial intelligence techniques to prepare and submit datasets and variables to cloud computing clusters and/or other analytical tools (e.g., predictive analytical tools) which may analyze such data using artificial intelligence neural networks. The exemplary disclosed system may for example include cloud computing clusters performing predictive analysis. For example, the exemplary neural network may include a plurality of input nodes that may be interconnected and/or networked with a plurality of additional and/or other processing nodes to determine a predicted result. Exemplary artificial intelligence processes may include filtering and processing datasets, processing to simplify datasets by statistically eliminating irrelevant, invariant or superfluous variables or creating new variables which are an amalgamation of a set of underlying variables, and/or processing for splitting datasets into train, test and validate datasets using at least a stratified sampling technique. The exemplary disclosed system may utilize prediction algorithms and approach that may include regression models, tree-based approaches, logistic regression, Bayesian methods, deep-learning and neural networks both as a stand-alone and on an ensemble basis, and final prediction may be based on the model/structure which delivers the highest degree of accuracy and stability as judged by implementation against the test and validate datasets.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

While multiple embodiments are disclosed, still other embodiments of the present disclosure will become apparent to those skilled in the art from this detailed description. There may be aspects of this disclosure that may be practiced without the implementation of some features as they are described. It should be understood that some details have not been described in detail in order to not unnecessarily obscure the focus of the disclosure. The disclosure is capable of myriad modifications in various obvious aspects, all without departing from the spirit and scope of the present disclosure. Accordingly, the drawings and descriptions are to be regarded as illustrative rather than restrictive in nature.

What is claimed is:

1. A system, comprising:
a mortgage servicing and loan valuation module, comprising computer-executable code stored in non-volatile memory;
a processor; and
a network component configured to communicate with the mortgage servicing and loan valuation module and the processor;
wherein the mortgage servicing and loan valuation module, the processor, and the network component are configured to:
receive a pricing file via the network component;
provide a plurality of machine learning regression models;
determine one or more of the plurality of machine learning regression models to apply to the pricing file;
apply the determined one or more of the plurality of machine learning regression models to the pricing file; and
transfer a priced portfolio to the network component.

2. The system of claim 1, wherein the mortgage servicing and loan valuation module, the processor, and the network component are further configured to receive a plurality of update data for the pricing file in real time.

3. The system of claim 1, wherein the plurality of update data for the pricing file includes real time changes to reference market rates.

4. The system of claim 1, wherein the plurality of machine learning regression models is a plurality of k-nearest neighbors models.

5. The system of claim 1, wherein applying the determined one or more of the plurality of machine learning regression models to the pricing file includes eliminating all local maxima beyond a preliminary threshold.

6. The system of claim 1, wherein applying the determined one or more of the plurality of machine learning regression models to the pricing file includes interpolating on a continuous plane using a regression based on k-nearest neighbors.

7. The system of claim 1, wherein the pricing file is a bulk mortgage loan level pricing file.

8. The system of claim 1, wherein the pricing file includes at least one data selected from the group of note rate data, escrow data, loan age data, UPB data, LTV data, FICO data, DTI data, and combinations thereof.

9. The system of claim 1, wherein the network component includes an Internet-based API.

10. The system of claim 1, wherein applying the determined one or more of the plurality of machine learning regression models to the pricing file includes interpolating between a granular population to provide continuous pricing in all market states and loan characteristics.

11. A method, comprising:
receiving a pricing file via a network component;
providing a plurality of k-nearest neighbors models;
determining one or more of the plurality of k-nearest neighbors models to apply to the pricing file using a mortgage servicing and loan valuation module and a processor;
applying the determined one or more of the plurality of k-nearest neighbors models to the pricing file; and
transferring a priced portfolio to the network component.

12. The method of claim 11, wherein determining one or more of the plurality of k-nearest neighbors models to apply to the pricing file using a mortgage servicing and loan valuation module and a processor includes utilizing machine learning operations.

13. The method of claim 11, further comprising receiving a plurality of update data for the pricing file.

14. The method of claim 13, further comprising updating the pricing file in real time as each of the plurality of update data is received.

15. The method of claim 13, wherein the plurality of update data includes real time changes to reference market rates.

16. A system, comprising:
a mortgage servicing and loan valuation module, comprising computer-executable code stored in non-volatile memory;
a processor; and
a network component including an API and configured to communicate with the mortgage servicing and loan valuation module and the processor;
wherein the mortgage servicing and loan valuation module, the processor, and the network component are configured to:
receive a pricing file via the network component;
provide a plurality of k-nearest neighbors models;
determine one or more of the plurality of k-nearest neighbors models to apply to the pricing file;
apply the determined one or more of the plurality of k-nearest neighbors models to the pricing file;
transfer a priced portfolio to the network component; and
receive a plurality of update data for the pricing file in real time.

17. The system of claim 16, wherein the mortgage servicing and loan valuation module, the processor, and the network component are further configured to update the pricing file in real time as each of the plurality of update data is received.

18. The system of claim 16, wherein the plurality of update data for the pricing file includes real time changes to reference market rates.

19. The system of claim 16, wherein applying the determined one or more of the plurality of k-nearest neighbors models to the pricing file includes eliminating all local maxima beyond a preliminary threshold.

20. The system of claim 16, wherein applying the determined one or more of the plurality of k-nearest neighbors models to the pricing file includes interpolating on a continuous plane using a regression based on k-nearest neighbors.
